(19) United States
(12) Patent Application Publication
(10) Pub. No.: US 2025/0100404 A1
(43) Pub. Date: Mar. 27, 2025

(54) VEHICLE CHARGING DEVICE

(71) Applicants: YAZAKI CORPORATION, Tokyo (JP); ShinMaywa Industries, Ltd., Takarazuka-shi (JP)

(72) Inventors: Yukinari Naganishi, Susono-shi (JP); Shigeru Yoneda, Susono-shi, Shizuoka (JP); Takashi Shiroki, Susono-shi (JP); Hajime Ojiro, Takarazuka-shi (JP); Kouhei Ootsuka, Takarazuka-shi (JP); Masahiro Namba, Takarazuka-shi (JP); Koji Ikegaya, Susono-shi (JP)

(21) Appl. No.: 18/830,586

(22) Filed: Sep. 11, 2024

(30) Foreign Application Priority Data
Sep. 21, 2023 (JP) 2023-154101
Nov. 27, 2023 (JP) 2023-200085

(51) Int. Cl. B60L 53/16; B60L 53/31

(52) U.S. Cl. CPC B60L 53/16; B60L 53/31

(57) ABSTRACT

A vehicle charging device includes a base unit, a sliding body on which a connector is disposed that is fit with an inlet in a vehicle, the sliding body being slidably supported by the base unit, and a routing structure that is routed between the base unit and the sliding body, has a curved portion curved in a U-shape, and follows a movement of the sliding body while changing a position of the curved portion. The routing structure includes, for example, a first exterior member, a first electric wire inserted into the first exterior member, a second exterior member, and a second electric wire inserted into the second exterior member, an outer diameter of the second electric wire is smaller than an outer diameter of the first electric wire, and the second exterior member is disposed alongside the first exterior member.

### CROSS-REFERENCE TO RELATED APPLICATION(S)

The present application claims priority to and incorporates by reference the entire contents of Japanese Patent Application No. 2023-154101 filed in Japan on Sep. 21, 2023 and Japanese Patent Application No. 2023-200085 filed in Japan on Nov. 27, 2023.

### BACKGROUND OF THE INVENTION

### 1. Field of the Invention

The present invention relates to a vehicle charging device.

### 2. Description of the Related Art

In the related art, there are charging apparatuses that charge vehicles. A vehicle charging system disclosed in Japanese Patent Application Laid-open No. 2022-26379 A includes a power supply device that includes a power supplying-side fitting body and is provided in a stop space of a vehicle. The vehicle charging system includes an insertion/removal direction movement unit that causes the power supplying-side fitting body to fit with a power receiving-side fitting body of a vehicle.

In a vehicle charging device in which a connector is moved by a sliding body, a routing structure that allows electric wires to follow the movement of the sliding body is required. It is desirable for such a vehicle charging device to be able to reduce the space for the routing structure.

### SUMMARY OF THE INVENTION

An object of the present invention is to provide a vehicle charging device that can reduce a space for a routing structure.

In order to achieve the above mentioned object, a vehicle charging device according to one aspect of the present invention includes a base unit that is fixed to a floor unit; a sliding body on which a connector is disposed, the connector being configured to fit with an inlet disposed in a vehicle, and the sliding body being slidably supported by the base unit; and a routing structure that is routed between the base unit and the sliding body, has a curved portion curved in a U-shape, and is configured to follow a movement of the sliding body while changing a position of the curved portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a vehicle charging device according to an embodiment;

FIG. 2 is a perspective view of the vehicle charging device according to the embodiment;

FIG. 3 is a plan view of the vehicle charging device according to the embodiment;

FIG. 4 is a perspective view of the vehicle charging device according to the embodiment;

FIG. 5 is a side view of the vehicle charging device according to the embodiment;

FIG. 6 is a plan view of a routing structure according to the embodiment;

FIG. 7 is a perspective view of the routing structure according to the embodiment;

FIG. 8 is a plan view of an exterior member according to the embodiment;

FIG. 9 is a plan view of the routing structure according to the embodiment;

FIG. 10 is a cross-sectional view of the routing structure according to the embodiment;

FIG. 11 is a side view of a load-bearing structure according to the embodiment;

FIG. 12 is a cross-sectional view of the load-bearing structure according to the embodiment;

FIG. 13 is a side view of the load-bearing structure according to the embodiment; and

FIG. 14 is a plan view of another form of the load-bearing structure according to the embodiment.

### DETAILED DESCRIPTION OF THE PREFERRED EMBODIMENTS

Hereinbelow, a vehicle charging device according to an embodiment of the present invention will be described in detail with reference to the drawings. The present invention is not limited to the present embodiment. In addition, components in the following embodiment include other components that can be readily conceivable by those skilled in the art or are substantially the same as each other.

### Embodiment

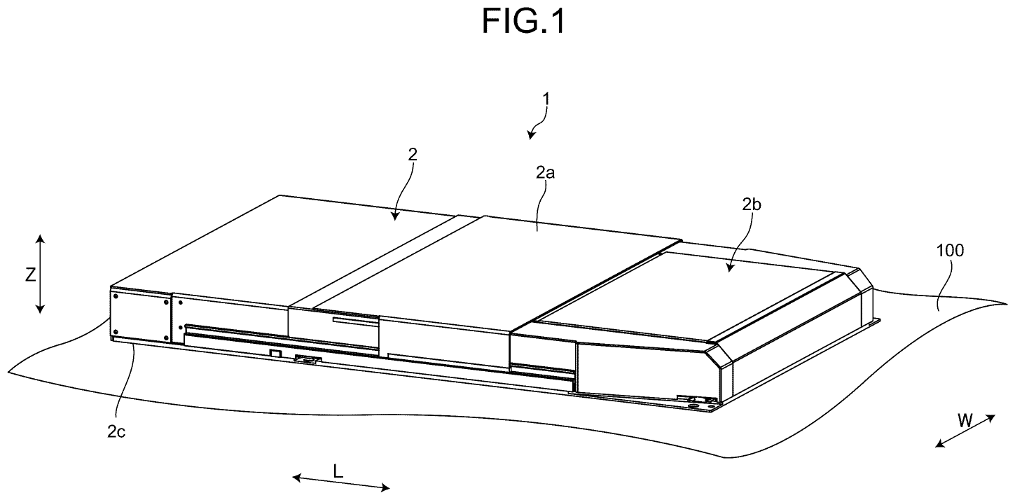

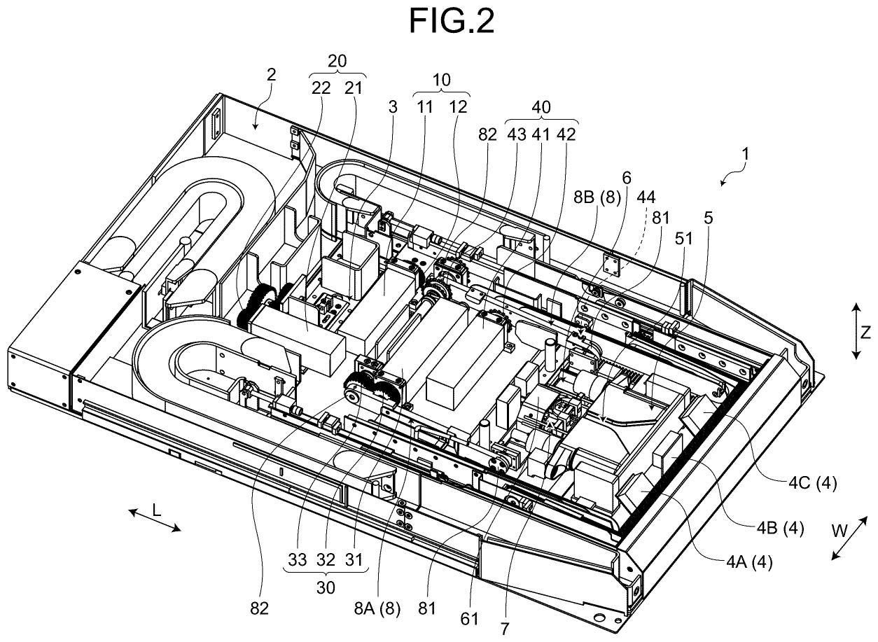

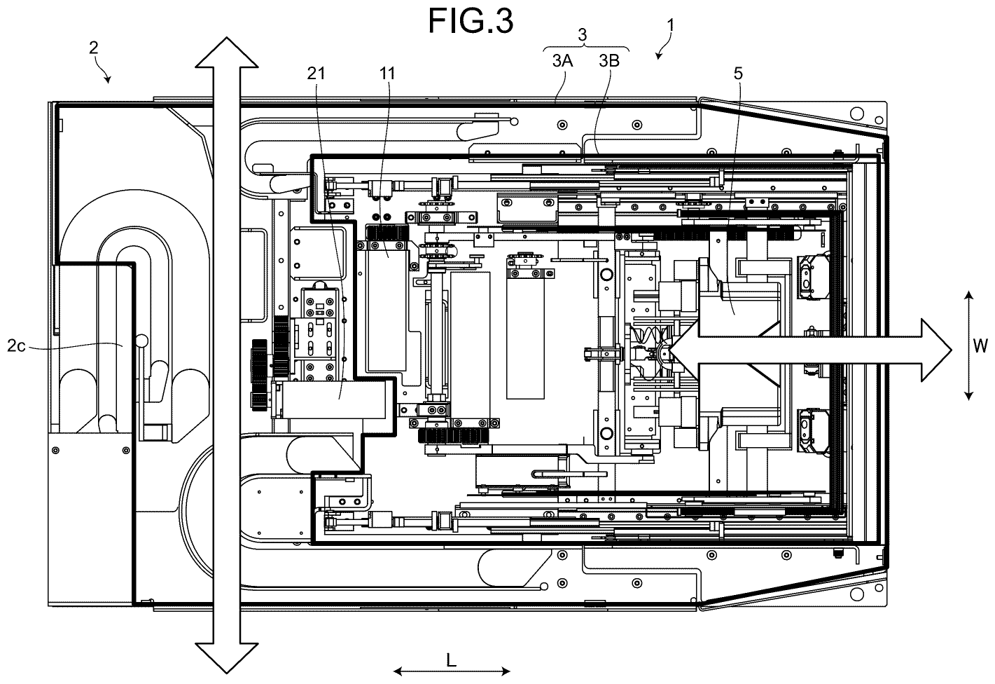

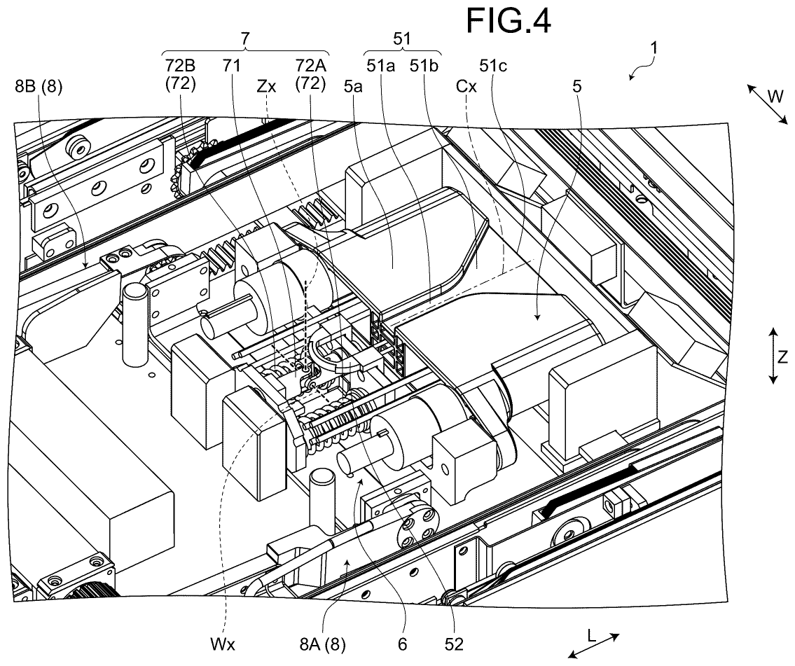

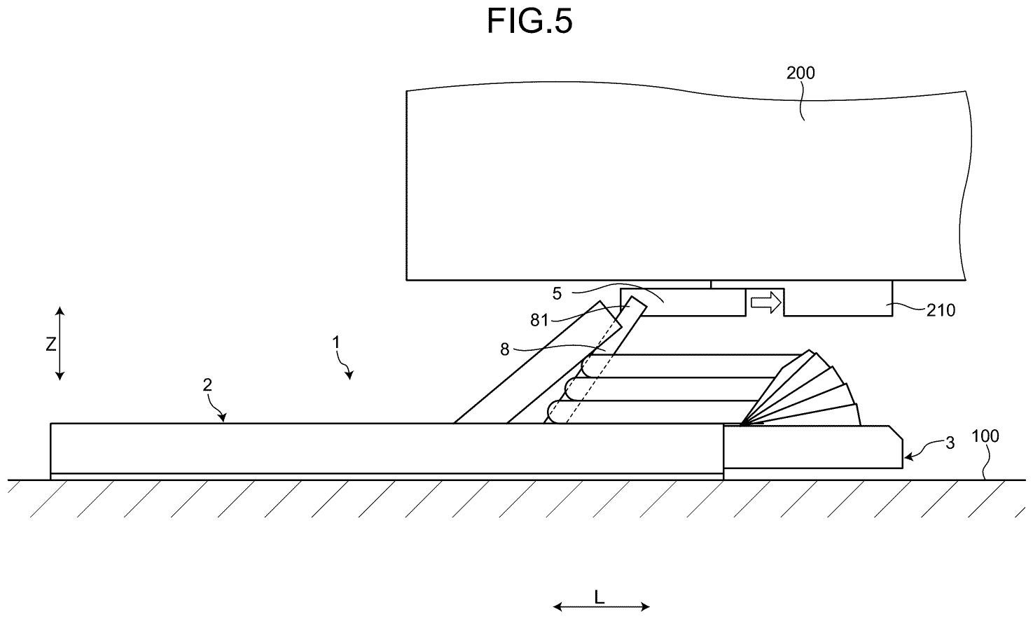

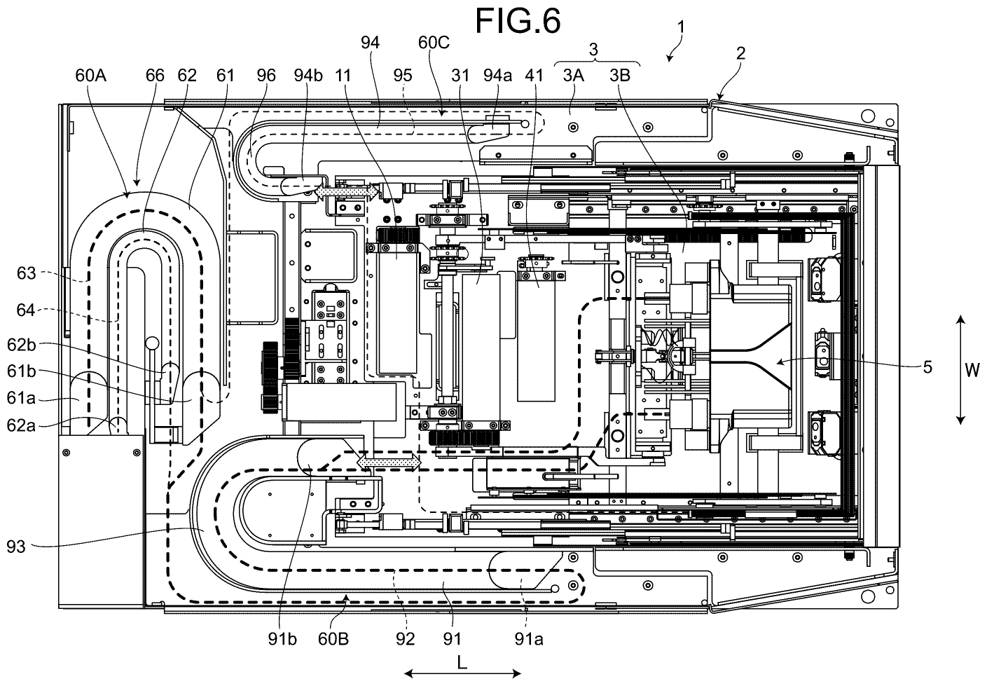

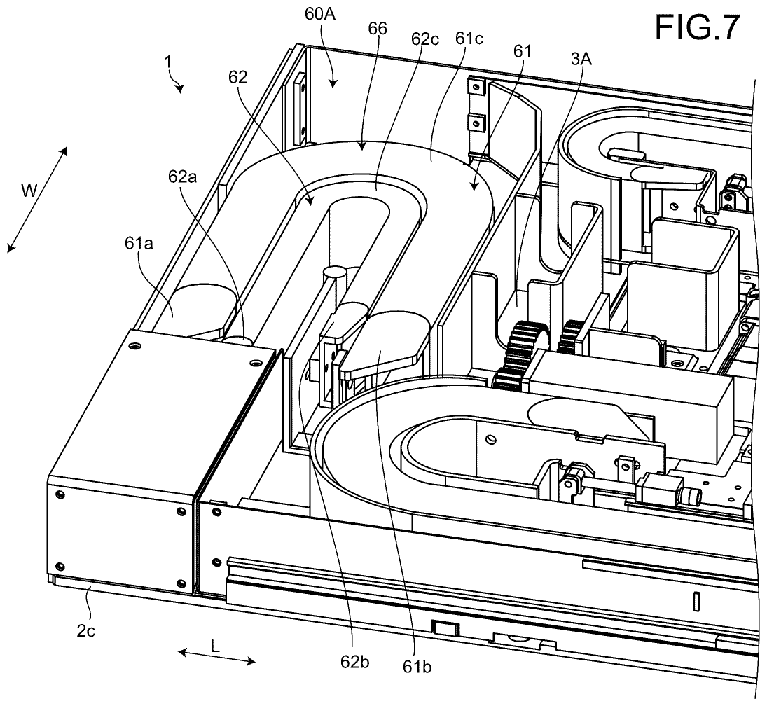

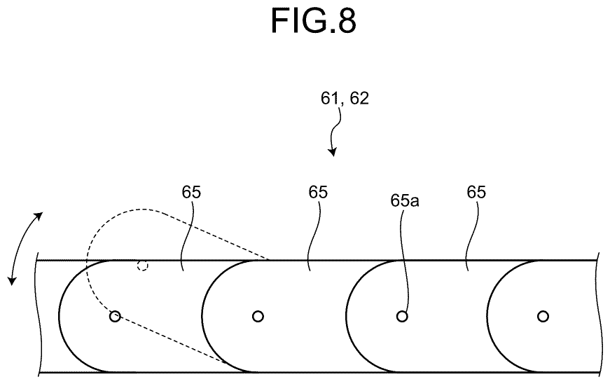

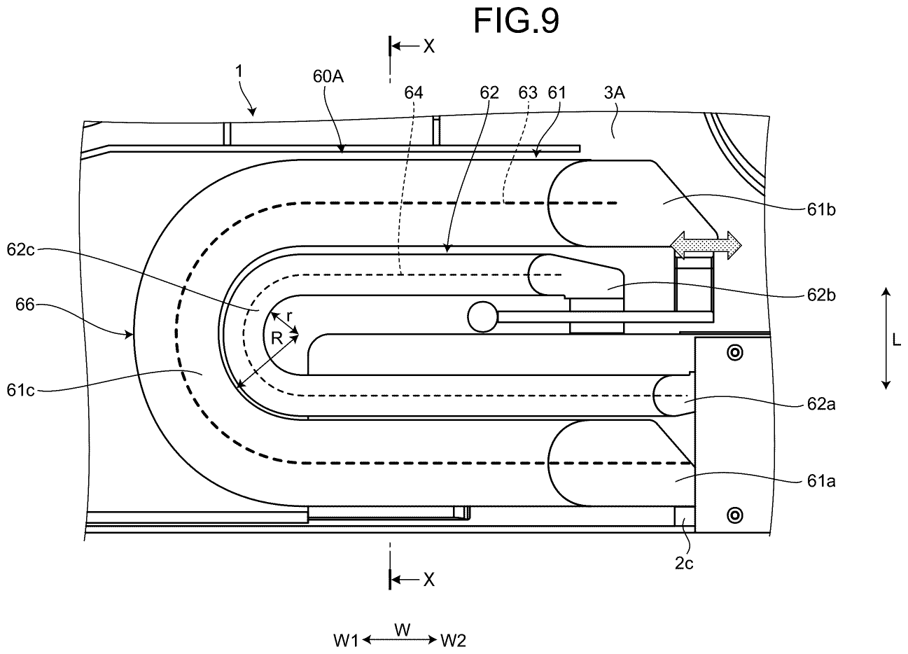

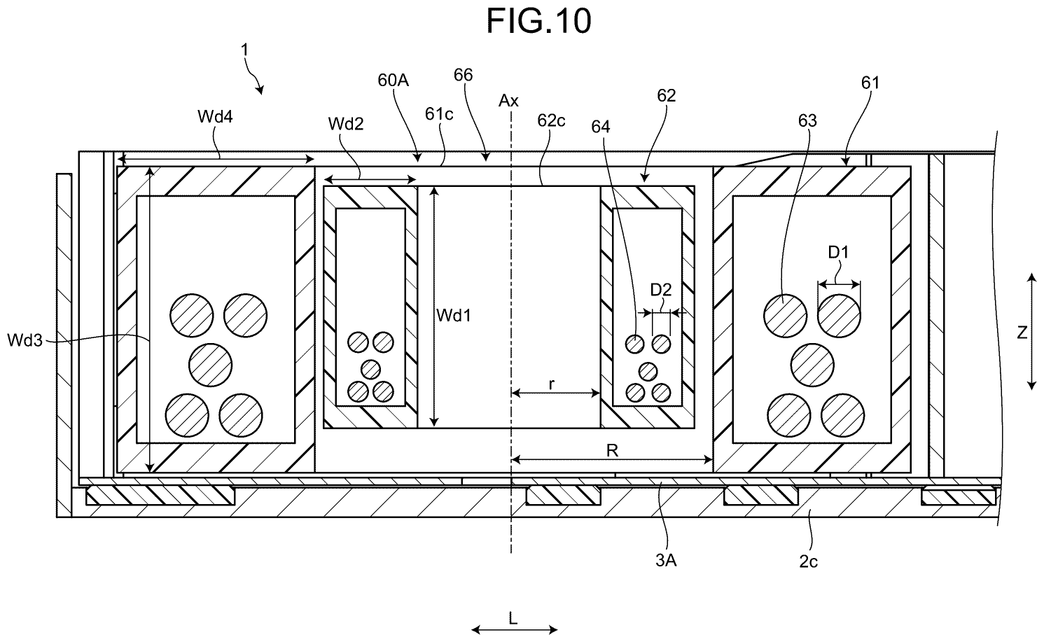

An embodiment will be described with reference to FIGS. 1 to 14. The present embodiment relates to a vehicle charging device. FIGS. 1 and 2 are perspective views of a vehicle charging device according to the embodiment, FIG. 3 is a plan view of the vehicle charging device according to the embodiment, FIG. 4 is a perspective view of the vehicle charging device according to the embodiment, FIG. 5 is a side view of the vehicle charging device according to the embodiment, FIG. 6 is a plan view of a routing structure according to the embodiment, FIG. 7 is a perspective view of the routing structure according to the embodiment, FIG. 8 is a plan view of an exterior member according to the embodiment, FIG. 9 is a plan view of the routing structure according to the embodiment, and FIG. 10 is a cross-sectional view of the routing structure according to the embodiment.

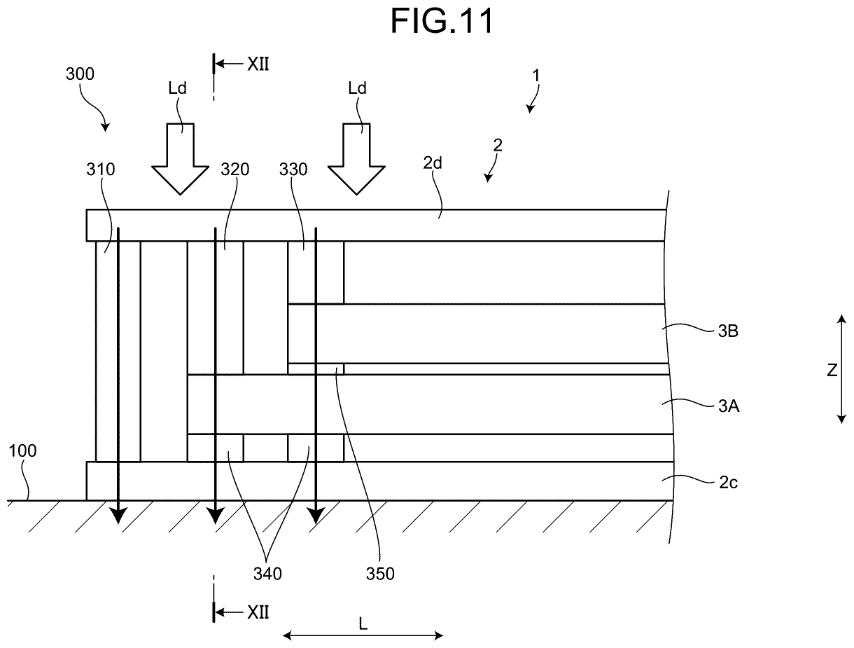

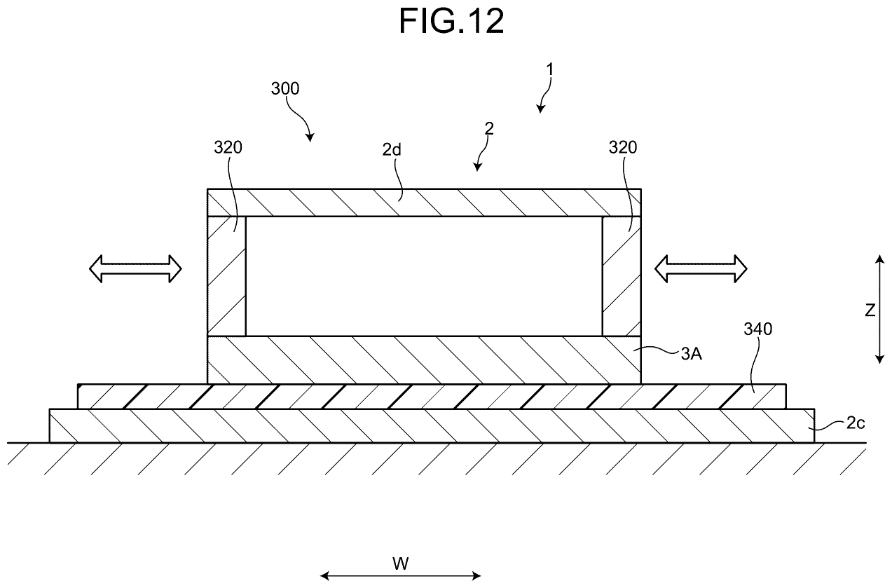

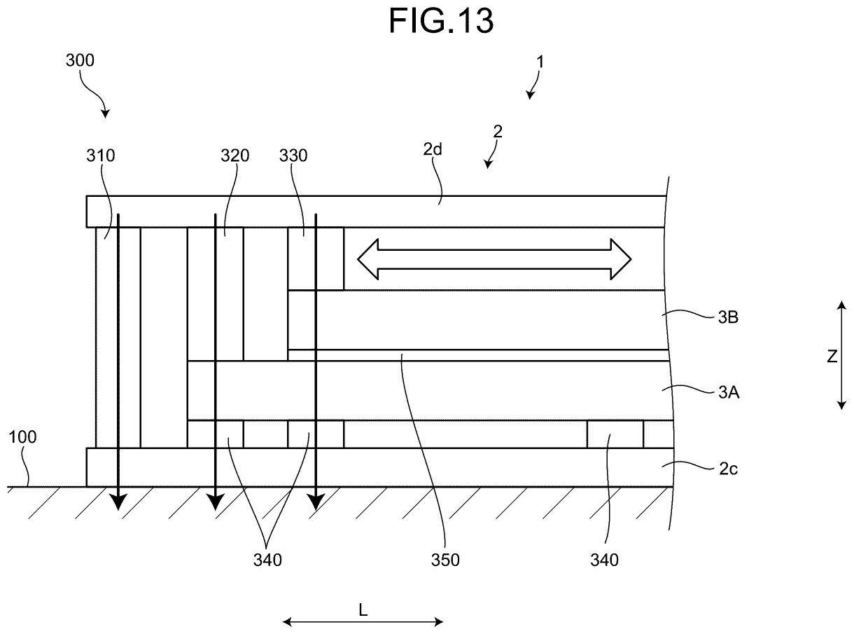

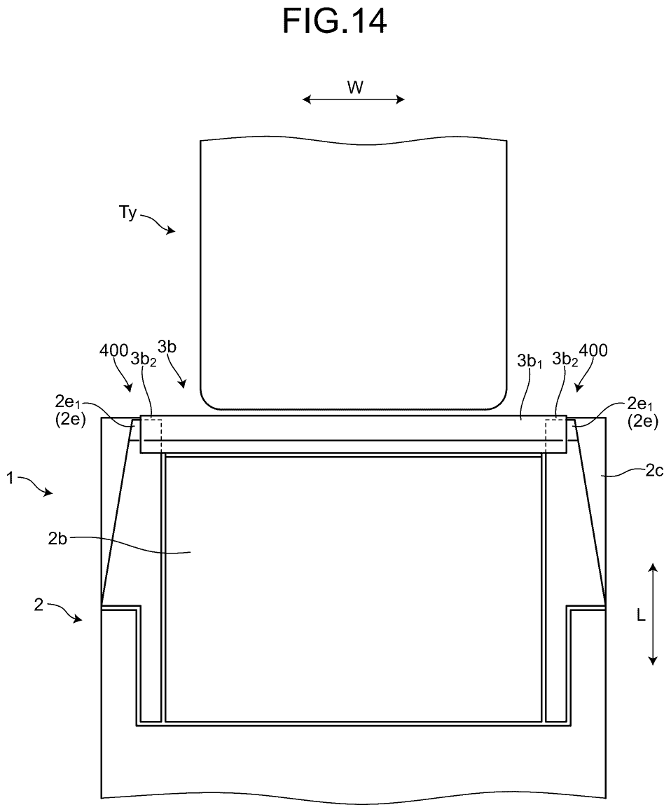

FIG. 11 is a side view of a load-bearing structure according to the embodiment, FIG. 12 is a cross-sectional view of the load-bearing structure according to the embodiment, and FIG. 13 is a side view of the load-bearing structure according to the embodiment. FIG. 14 is a plan view of another form of the load-bearing structure according to the embodiment. FIG. 10 illustrates X-X cross-section of FIG. 9. FIG. 12 illustrates XII-XII cross-section of FIG. 11.

As illustrated in FIG. 1, a vehicle charging device 1 of the present embodiment is placed on a floor unit 100 of a stop space where a vehicle is stopped. The vehicle charging device 1 includes a housing 2. The housing 2 includes a base unit 2c that is fixed to the floor unit 100. The base unit 2c is a foundation unit of the vehicle charging device 1 and is formed of a metal plate, for example. The housing 2 includes a sliding cover 2a and a rotationally moving cover 2b. The covers 2a and 2b cover the apparatus housed in the interior space of the housing 2 from the top.

As illustrated in FIG. 2, the vehicle charging device 1 includes a sliding body 3 disposed inside the housing 2. The sliding body 3 includes a first sliding body 3A and a second sliding body 3B, as illustrated in FIG. 3. The first sliding body 3A is slidably supported by the base unit 2c. The first sliding body 3A is movable in a second direction W with respect to the base unit 2c. The second sliding body 3B is slidably supported by the first sliding body 3A. The second sliding body 3B is movable in a first direction L with respect to the first sliding body 3A. The first direction L and the second direction W are horizontal. In a case where a floor surface of the floor unit 100 is sloped, the first direction L and the second direction W are preferably parallel to the floor surface of the floor unit 100.

The first direction L corresponds to a vehicle front-rear direction of a vehicle 200 to be charged. The second direction W corresponds to a vehicle width direction of the vehicle 200. The vehicle 200 is positioned at a charging position so as to be charged by the vehicle charging device 1 while moving forward or backward along the first direction L. In the exemplified vehicle charging device 1, the first direction L is a longitudinal direction of the housing 2. The second direction W is a lateral direction of the housing 2 and is perpendicular to the first direction L.

As illustrated in FIG. 2, the vehicle charging device 1 includes sensors 4, a connector 5, a support member 6, a coupling mechanism 7, and arms 8. The vehicle charging device 1 further includes a first driving mechanism 10, a second driving mechanism 20, a third driving mechanism 30, and a fourth driving mechanism 40.

As illustrated in FIG. 5, the connector 5 is fit with an inlet 210 disposed in the vehicle 200. The inlet 210 is disposed on the bottom of the vehicle 200. The connector 5 is connected to a battery of the vehicle 200 by the fitting with the inlet 210.

The sensors 4 are used to detect a position of the inlet 210. The sensors 4 may be distance-measuring sensors, sensors that capture images and detect objects in the images, or any other position-detecting sensors. The sensors 4 may include a plurality of sensors with different detection methods. The sensors 4 of the present embodiment are laser sensors that detect the distance to a reflective object by laser beams. The sensors 4 emit laser beams in a predetermined direction and receive the laser beams reflected by the object.

The sensors 4 are disposed on the second sliding body 3B and moves together with the second sliding body 3B. The sensors 4 illustrated in FIG. 2 include a first sensor 4A, a second sensor 4B, and a third sensor 4C. The three sensors 4A, 4B, and 4C are disposed side by side in this order in the second direction W. The second sensor 4B emits a laser beam upward in a vertical direction Z. The vertical direction is perpendicular to both the first direction L and the second direction W, and corresponds to a vehicle vertical direction of the vehicle 200. The first sensor 4A and the third sensor 4C emit laser beams in an oblique direction inclined with respect to the vertical direction Z.

The connector 5 is a charging connector for charging the battery of the vehicle 200. The connector 5 includes a terminal for charging. The vehicle charging device 1 of the present embodiment is configured such that a position of the connector 5 can be moved in the first direction L, the second direction W, and the vertical direction Z.

The first driving mechanism 10 is a mechanism that causes the connector 5 to move in the first direction L. The first driving mechanism 10 includes a first motor 11 and a gear wheel 12. The first motor 11 is disposed on the second sliding body 3B. The gear wheel 12 is disposed on an output shaft of the first motor 11 and meshes with a rack gear disposed on the first sliding body 3A. The first motor 11 can rotate forward and reverse to move the second sliding body 3B and the connector 5 in the first direction L.

The second driving mechanism 20 is a mechanism that causes the connector 5 to move in the second direction W. The second driving mechanism 20 includes a second motor 21 and a gear wheel 22. The second motor 21 is disposed in the first sliding body 3A. The gear wheel 22 is disposed on an output shaft of the second motor 21. The gear wheel 22 meshes with a rack gear disposed on the base unit 2c of the housing 2 via a reduction gear. The second motor 21 can rotate forward and reverse to move the first sliding body 3A and the second sliding body 3B in the second direction W.

The third driving mechanism 30 is a mechanism that causes the connector 5 to move in the vertical direction Z. The connector 5 is coupled to the second sliding body 3B with the arms 8, the support member 6, and the coupling mechanism 7. Each of the arms 8 is a plate-like member and has a first end portion 81 and a second end portion 82. The first end portion 81 is coupled to the support member 6. The second end portion 82 is rotatably supported by the second sliding body 3B. In other words, each of the arms 8 can rotate with the second end portion 82 as the center of rotation. The arms 8 rotationally move to raise and lower the support member 6.

The vehicle charging device 1 of the present embodiment has a first arm 8A and a second arm 8B. The first arm 8A and the second arm 8B extend in the first direction L and face each other in the second direction W. The second end portions 82 of the two arms 8A and 8B are connected to each other via a shaft. Thus, the two arms 8A and 8B rotate in conjunction.

The support member 6 is coupled to the first end portion 81 of the first arm 8A and the first end portion 81 of the second arm 8B. The support member 6 is a plate-like member and extends in the second direction W. The support member 6 is axially supported by the first end portions 81 of the arms 8 such that the support member 6 can rotate relative to the arms 8.

The coupling mechanism 7 couples the connector 5 to the support member 6 and is configured to allow changes in orientation of the connector 5. As illustrated in FIG. 4, the coupling mechanism 7 has a universal joint 71 and springs 72. The universal joint 71 and the springs 72 are disposed between the support member 6 and the connector 5 and extend in the first direction L. One end of the universal joint 71 and one end of each spring 72 are connected to the support member 6, and the other end of the universal joint 71 and the other end of each spring 72 are connected to the connector 5.

A bearing may be disposed between the universal joint 71 and the connector 5. In this case, the bearing allows rotation of the connector 5 with the center axis line in the first direction L as the center of rotation. In a case where the bearing is provided, the connector 5 can rotate relative to the universal joint 71.

The universal joint 71 in the present embodiment allows changes in the orientation of the connector 5 in the two rotation directions. More specifically, the universal joint 71 allows rotation of the connector 5 with a center axis line Wx in the second direction W as the center of rotation. The universal joint 71 further allows rotation of the connector 5 with the center axis line Zx in the vertical direction Z as the center of rotation. The universal joint 71 is, for example, a cross joint.

The springs 72 includes a first spring 72A and a second spring 72B. The first spring 72A and the second spring 72B are disposed on both sides along the second direction W with the universal joint 71 interposed therebetween. A spring force is applied to the connector 5 by the first spring 72A and the second spring 72B to return a position of the connector 5 to the neutral position in a rotation direction.

The third driving mechanism 30 causes the arms 8 to move rotationally, thereby the connector 5 moving in the vertical direction Z. As illustrated in FIG. 2, the third driving mechanism 30 includes a third motor 31, a first gear wheel 32, and a second gear wheel 33. The third motor 31 is disposed on the second sliding body 3B. The first gear wheel 32 is disposed on an output shaft of the third motor 31. The second gear wheel 33 is connected to the shaft coupling the two arms 8A and 8B and meshes with the first gear wheel 32. The third motor 31 rotates forward and reverse to rotate the arms 8.

The fourth driving mechanism 40 is configured to change an angle θ of the connector 5. The angle θ is an inclination angle of the connector 5 with respect to the first direction L. The fourth driving mechanism 40 includes a fourth motor 41, a first sprocket 42, and a pair of second sprockets 43. The fourth motor 41 is disposed on the second sliding body 3B. The first sprocket 42 is disposed on an output shaft of the fourth motor 41. The second sprockets 43 are coaxially disposed with the shaft coupling the arms 8A and 8B and rotate relative to the shaft. An endless chain is wrapped around the first sprocket 42 and one of the second sprockets 43. A third sprocket 44 is disposed on the support member 6. An endless chain is wrapped around the other second sprocket 43 and the third sprocket 44. The fourth motor 41 rotates forward and reverse to rotate the support member 6 relative to the arms 8A and 8B. The angle θ of the connector 5 changes in response to rotation of the support member 6. As illustrated in FIG. 6, the vehicle charging device 1 has a first routing structure 60A, a second routing structure 60B, and a third routing structure 60C. The routing structures 60A, 60B, and 60C are structures for routing electric wires for supplying power, signals, and other elements to each device in the vehicle charging device 1.

The first routing structure 60A is routed between the base unit 2c and the first sliding body 3A. As illustrated in FIGS. 6 and 7, the first routing structure 60A includes a first exterior member 61, a second exterior member 62, a first electric wire 63, and a second electric wire 64.

The first and second exterior members 61 and 62 are flexible tubular members. The first exterior member 61 and the second exterior member 62 are molded with, for example, an insulating synthetic resin. The first exterior member 61 and the second exterior member 62 are formed of, for example, a plurality of tubular units 65 coupled to each other, as illustrated in FIG. 8. The tubular units 65 are a tubular member into which the electric wires 63 and 64 can be inserted. The cross-sectional shape of each of the tubular units 65 is, for example, rectangular. TWO adjacent tubular units 65 are coupled by a shaft 65a to rotate relative to each other.

As illustrated in FIGS. 6 and 7, the first exterior member 61 has a first end portion 61a and a second end portion 61b. The second exterior member 62 has a first end portion 62a and a second end portion 62b. The first end portions 61a and 62a are fixed to the base unit 2c. The second end portions 61b and 62b are fixed to the first sliding body 3A. The second end portions 61b and 62b move in the second direction W following the first sliding body 3A.

The first routing structure 60A is disposed to have a curved portion 66. The curved portion 66 is curved in a convex U-shape in the second direction W. The second exterior member 62 is disposed alongside the first exterior member 61 such that the second exterior member 62 is positioned radially inward relative to the first exterior member 61 at the curved portion 66. In other words, the second exterior member 62 is disposed in a region surrounded by the first exterior member 61. The curved portion 66 is formed with a first curved portion 61c that is included in the first exterior member 61 and a second curved portion 62c that is included in the second exterior member 62. The second curved portion 62c is positioned radially inward relative to the first curved portion 61c. The first end portions 61a and 62a and the second end portions 61b and 62b open toward the same side in the second direction W.

As illustrated in FIG. 9, the first exterior member 61 has an inner diameter R at the first curved portion 61c. A movable range of the tubular units 65 of the first exterior member 61 is regulated to achieve the inner diameter R at the first curved portion 61c. The second exterior member 62 has an inner diameter r at the second curved portion 62c. A movable range of the tubular units 65 of the second exterior member 62 is regulated to achieve the inner diameter r at the second curved portion 62c. The inner diameter R of the first curved portion 61c is larger than the inner diameter r of the second curved portion 62c.

The second end portions 61b and 62b of the first exterior member 61 and second exterior member 62 are connected to the first sliding body 3A. In other words, the second end portions 61b and 62b slide in the second direction W with respect to the base unit 2c together with the first sliding body 3A. As the second end portions 61b and 62b are moved, the position of the curved portion 66 in the first routing structure 60A is changed. More specifically, as the second end portions 61b and 62b are moved toward a first side W1 in the second direction W, the position of the curved portion 66 is moved closer to the second end portions 61b and 62b. In contrast, as the second end portions 61b and 62b are moved toward a second side W2 in the second direction W, the position of the curved portion 66 is moved closer to the first end portions 61a and 62a.

As illustrated in FIG. 10, each of the first exterior member 61 and the second exterior member 62 of the embodiment has a rectangular cross-sectional shape. At least a first electric wire 63 is inserted into the first exterior member 61. The inner diameter R of the first exterior member 61 is defined according to an outer diameter D1 of the first electric wire 63. In a case where a plurality of the first electric wires 63 is inserted into the first exterior member 61, the inner diameter R is determined according to the outer diameter D1 of the first electric wire 63 with the maximum diameter.

At least a second electric wire 64 is inserted into the second exterior member 62. The inner diameter r of the second exterior member 62 is defined according to an outer diameter D2 of the second electric wire 64. In a case where a plurality of the second electric wires 64 is inserted into the second exterior member 62, the inner diameter r is determined according to the outer diameter D2 of the second electric wire 64 with the maximum diameter. The outer diameter D2 of the second electric wire 64 is smaller than the outer diameter D1 of the first electric wire 63. In other words, the first electric wire 63 having the relatively large outer diameter D1 is inserted into the first exterior member 61, and the second electric wire 64 having the relatively small outer diameter D2 is inserted into the second exterior member 62. Here, the fact that the outer diameter D2 of the second electric wire 64 is smaller than the outer diameter D1 of the first electric wire 63 means that, for example, the outer diameter D2 of the second electric wire 64 with the maximum diameter is smaller than the outer diameter D1 of the first electric wire 63 with the maximum diameter.

The cross-sectional shape of the second exterior member 62 is rectangular with a width Wd1 in a direction along an axis Ax of the curved portion 66 being wider than a width Wd2 in a radial direction. In other words, the cross-sectional shape of the second exterior member 62 is a rectangle with the vertical direction Z as a longitudinal direction. Such a cross-sectional shape ensures both the required inner diameter r and a sufficient cross-sectional area in the second exterior member 62.

The cross-sectional shape of the first exterior member 61 is rectangular with a width Wd3 in a direction along the axis Ax of the curved portion 66 is wider than a width Wd4 in a radial direction. In other words, the cross-sectional shape of the first exterior member 61 is a rectangle with the vertical direction Z as a longitudinal direction. Such a cross-sectional shape ensures both the required inner diameter R and a sufficient cross-sectional area in the first exterior member 61.

In the first routing structure 60A of the present embodiment, a flattening F2 of the second exterior member 62 is greater than a flattening F1 of the first exterior member 61. The flattening F1 and the flattening F2 are calculated by the following equations (1) and (2).

$$F 1 = ( Wd 3 - Wd 4 ) / Wd 3 \qquad ( 1 )$$

$$F 2 = ( Wd 1 - Wd 2 ) / Wd 1 \qquad ( 2 )$$

As described above, a flattening degree of the second exterior member 62 is greater than a flattening degree of the first exterior member 61. In other words, the second exterior member 62 has an elongated cross-sectional shape as compared to the first exterior member 61. Since the second electric wire 64 having a small diameter is inserted into the second exterior member 62, the width Wd2 in the radial direction can be reduced. The flattening F2 of the second exterior member 62 is determined based on the inner diameter R to be ensured in the first exterior member 61, the inner diameter r to be ensured in the second exterior member 62, and the cross-sectional area required in the second exterior member 62.

According to the first routing structure 60A of the present embodiment, the second routing structure 60B is disposed in a space closer to the center in the first direction L than the first routing structure 60A is. Accordingly, an area for routing the first electric wire 63 and the second electric wire 64 in the housing 2 can be minimized.

As illustrated in FIG. 6, the second routing structure 60B and the third routing structure 60C are respectively disposed at end portions of the first sliding body 3A in the second direction W. The first electric wire 63 and the second electric wire 64 are connected to a device of the second sliding body 3B via the second routing structure 60B or the third routing structure 60C.

The second routing structure 60B includes a third exterior member 91 and an electric wire 92. The third exterior member 91 is a flexible tubular member. The third exterior member 91 is formed of, for example, a plurality of tubular units 65 coupled to each other. The electric wire 92 inserted into the third exterior member 91 is, for example, the first electric wire 63. The first electric wire 63 includes, for example, a power supply electric wire that is connected to a terminal of the connector 5.

The second routing structure 60B is disposed to have a curved portion 93. The curved portion 93 is curved in a convex U-shape in the first direction L. The third exterior member 91 has a first end portion 91a and a second end portion 91b. The first end portion 91a is connected to the first sliding body 3A. The second end portion 91b is connected to the second sliding body 3B. Accordingly, the second routing structure 60B follows the second sliding body 3B while changing a position of the curved portion 93 when the second sliding body 3B moves relative to the first sliding body 3A along the first direction L. In a case where the electric wire 92 is the first electric wire 63, the third exterior member 91 is configured such that the curved portion 93 has an inner diameter R.

The third routing structure 60C includes a fourth exterior member 94 and an electric wire 95. The fourth exterior member 94 is a flexible tubular member. The fourth exterior member 94 is formed of, for example, a plurality of tubular units 65 coupled to each other. The electric wire 95 inserted into the fourth exterior member 94 is, for example, the second electric wire 64. The second electric wire 64 includes, for example, a communication line, a power supply line having a small diameter, or other wiring.

The third routing structure 60C is disposed to have a curved portion 96. The curved portion 96 is curved in a convex U-shape in the first direction L. The fourth exterior member 94 has a first end portion 94a and a second end portion 94b. The first end portion 94a is connected to the first sliding body 3A. The second end portion 94b is connected to the second sliding body 3B. Accordingly, the third routing structure 60C follows the second sliding body 3B while changing a position of the curved portion 96 when the second sliding body 3B moves relative to the first sliding body 3A along the first direction L. In a case where the electric wire 95 is the second electric wire 64, the fourth exterior member 94 is configured such that the curved portion 96 has an inner diameter r.

In the vehicle charging device 1 of the present embodiment, the second routing structure 60B and the third routing structure 60C are disposed at the separate end portions in the second direction W. Therefore, the electric wires can be disposed efficiently. For example, electric wires can be routed at both sides in the second direction W with respect to the motors 11, 31, and 41, and the connector 5.

In the present embodiment, the first electric wire 63 is inserted into the third exterior member 91, and the second electric wire 64 is inserted into the fourth exterior member 94. Therefore, the space where the fourth exterior member 94 is disposed is minimized. As a comparative example, the first electric wire 63 is inserted into the third exterior member 91, and another portion of the first electric wire 63 is inserted into the fourth exterior member 94. In this case, the curved portion 96 of the fourth exterior member 94 is required to have the inner diameter R. In contrast, in a case where the electric wire 95 inserted into the fourth exterior member 94 is the second electric wire 64, it is sufficient that the curved portion 96 has the inner diameter r.

The vehicle charging device 1 of the present embodiment has a load-bearing structure as described below, since the vehicle charging device 1 is placed in a stop space of the vehicle 200. The load-bearing structure of the present embodiment can achieve both reducing the frictional resistance generated when the first sliding body 3A and the second sliding body 3B move and ensuring the resistance to the load of the vehicle 200.

As illustrated in FIG. 11, a load-bearing structure 300 includes a first prop 310, a second prop 320, a third prop 330, a first buffer member 340, and a second buffer member 350. The first prop 310, the second prop 320, and the third prop 330 are props that support a load Ld in the vertical direction Z, and are members formed of, for example, metal. The first buffer member 340 and the second buffer member 350 are disposed in a gap between two members. The first buffer member 340 and the second buffer member 350 are rigid enough to support the load Ld. The first buffer member 340 and the second buffer member 350 preferably have a small frictional coefficient. The first buffer member 340 and the second buffer member 350 are formed of, for example, a synthetic resin or metal.

The first prop 310 is disposed between the base unit 2c and a cover 2d of the housing 2. The cover 2d is a member that covers the base unit 2c from above. The cover 2d is disposed closer to the upper side than the first sliding body 3A and the second sliding body 3B are, and covers the first sliding body 3A and the second sliding body 3B. The first prop 310 is fixed to at least one of the cover 2d or the base unit 2c, for example. The base unit 2c supports the first prop 310 and the cover 2d from below against the load Ld.

The second prop 320 is disposed between the cover 2d and the first sliding body 3A. The second prop 320 is fixed to either the cover 2d or the first sliding body 3A, for example. The first buffer member 340 is plate-shaped and interposed between the base unit 2c and the first sliding body 3A. The first buffer member 340 is disposed on the opposite side to the second prop 320, with the first sliding body 3A interposed. In other words, the base unit 2c supports the first buffer member 340 and the first sliding body 3A from below against the load Ld. The first sliding body 3A supports the second prop 320 and the cover 2d from below against the load Ld.

The third prop 330 is disposed between the cover 2d and the second sliding body 3B. The third prop 330 is fixed to either the cover 2d or the second sliding body 3B, for example. The second buffer member 350 is plate-shaped and interposed between the first sliding body 3A and the second sliding body 3B. The second buffer member 350 is disposed on the opposite side to the third prop 330, with the second sliding body 3B interposed. The first buffer member 340 is disposed on the opposite side to the second buffer member 350, with the first sliding body 3A interposed. The first sliding body 3A supports the second buffer member 350, the second sliding body 3B, the third prop 330, and the cover 2d from below against the load Ld.

Thus, the load-bearing structure 300 supports the load Ld at a plurality of locations by a plurality of the props 310, 320, and 330, and a plurality of the buffer members 340 and 350. In other words, the load-bearing structure 300 enables transfer path distribution of the load Ld between the cover 2d and the base unit 2c. Therefore, the load-bearing performance in the vehicle charging device 1 is improved.

As illustrated in FIG. 12, the second props 320 are disposed in a plurality of locations along the second direction W. The second props 320 may be disposed at both end portions of the first sliding body 3A in the second direction W. Furthermore, the second props 320 may be disposed at the center in the second direction W.

The first buffer member 340 is, for example, disposed on the base unit 2c and held by the base unit 2c. The base unit 2c may have a recessed portion to hold the first buffer member 340. In a case where the first buffer member 340 is held by the base unit 2c, the first buffer member 340 extends to the range in which the second prop 320 is movable in the second direction W. The exemplified first buffer member 340 is disposed constantly on the opposite side to the second prop 320 in a case where the second prop 320 moves in the second direction W together with the first sliding body 3A. Therefore, the load-bearing structure 300 of the present embodiment can stably support the load Ld acting on the second prop 320.

The first buffer member 340 may be disposed on the underside of the first sliding body 3A and fixed to the first sliding body 3A. In this case, the load-bearing structure 300 may be configured such that both the first buffer member 340 and the second prop 320 move with the first sliding body 3A.

The second buffer member 350 may be disposed on the underside of the second sliding body 3B and fixed to the second sliding body 3B. In this case, the load-bearing structure 300 may be configured such that both the second buffer member 350 and the third prop 330 move with the second sliding body 3B.

The second buffer member 350 may be disposed on the first sliding body 3A and held by the first sliding body 3A. The first sliding body 3A may have a recessed portion to hold the second buffer member 350. In a case where the second buffer member 350 is held by the first sliding body 3A, the second buffer member 350 extends to the range in which the third prop 330 can move in the first direction L, as illustrated in FIG. 13. The second buffer member 350 illustrated in FIG. 13 is disposed constantly on the opposite side to the third prop 330 in a case where the third prop 330 moves in the first direction L together with the second sliding body 3B. Therefore, the load-bearing structure 300 in FIG. 13 can stably support the load acting on the third prop 330. A plurality of the first buffer members 340 may be disposed with respect to the second buffer member 350. For example, as illustrated in FIG. 13, the first buffer members 340 may be disposed against both end portions of the second buffer member 350 in the first direction L.

As explained above, the vehicle charging device 1 of the present embodiment includes the base unit 2c, the sliding body 3, and the first routing structure 60A. The base unit 2c is fixed to the floor unit 100. In the sliding body 3, the connector 5 is disposed that is configured to fit with the inlet 210 disposed in the vehicle 200 and is slidably supported by the base unit 2c. The first routing structure 60A is routed between the base unit 2c and the first sliding body 3A. The first routing structure 60A has the curved portion 66 that is curved in a U-shape and follows the movement of the first sliding body 3A while changing the position of the curved portion 66. Since the first routing structure 60A of the present embodiment follows the movement of the first sliding body 3A while changing the position of the U-shaped curved portion 66, the space for the routing structure can be reduced. For example, it is possible to minimize the space required to accommodate the excess length.

The first routing structure 60A of the present embodiment includes the first exterior member 61, the first electric wire 63, the second exterior member 62, and the second electric wire 64. The first electric wire 63 is inserted into the first exterior member 61, and the second electric wire 64 is inserted into the second routing structure 60B. The outer diameter D2 of the second electric wire 64 is smaller than the outer diameter D1 of the first electric wire 63. The second exterior member 62 is disposed alongside the first exterior member 61 such that the second exterior member 62 is positioned radially inward relative to the first exterior member 61 at the curved portion 66. In the vehicle charging device 1 of the present embodiment, the second exterior member 62 is disposed radially inward from the first exterior member 61 by using the difference between the inner diameter R required for the first exterior member 61 and the inner diameter r required for the second exterior member 62. Therefore, the space required for routing of the electric wires 63 and 64 can be reduced.

The cross-sectional shape of the second exterior member 62 of the present embodiment is rectangular with the width Wd1 along the axial direction of the curved portion 66 being wider than the width Wd2 in the radial direction. At the curved portion 66, the outside of the second exterior member 62 is regulated by the inner diameter R of the first exterior member 61. Furthermore, the second exterior member 62 is regulated to the inner diameter r at the curved portion 66. The second exterior member 62 of the present embodiment meets the dimensional requirements in the radial direction by employing the longitudinally elongated rectangular cross-sectional shape as described above.

The cross-sectional shape of the first exterior member 61 of the present embodiment is rectangular with the width Wd3 along the axial direction of the curved portion 66 being wider than the width Wd4 in the radial direction. The flattening F2 of the second exterior member 62 is greater than the flattening F1 of the first exterior member 61. The second electric wire 64 having a relatively small diameter is inserted into the second exterior member 62 to achieve the above flattening relationship. The vehicle charging device 1 of the present embodiment can reduce the space required for routing of the electric wires 63 and 64.

The vehicle charging device 1 of the present embodiment includes the cover 2d that covers the base unit 2c and the load-bearing structure 300. The load-bearing structure 300 is disposed between the base unit 2c and the cover 2d. The sliding body 3 includes the first sliding body 3A and the second sliding body 3B. The first sliding body 3A is supported by the base unit 2c and slides in the second direction W with respect to the base unit 2c. The second sliding body 3B is supported by the first sliding body 3A and slides in the first direction L with respect to the first sliding body 3A.

The load-bearing structure 300 includes the second prop 320, the third prop 330, the first buffer member 340, and the second buffer member 350. The second prop 320 is disposed between the cover 2d and the first sliding body 3A. The third prop 330 is disposed between the cover 2d and the second sliding body 3B. The first buffer member 340 is interposed between the first sliding body 3A and the base unit 2c. The second buffer member 350 is interposed between the second sliding body 3B and the first sliding body 3A. The load-bearing structure 300 can properly support the load Ld applied onto the cover 2d by the props.

The number, arrangement, and angles of the sensors 4 in the vehicle charging device 1 are not limited to the number, arrangement, and angles exemplified. For example, the vehicle charging device 1 can acquire the position of a projection (not illustrated) and the yaw angle α, roll angle γ, and pitch angle β of the inlet 210 by using at least one sensor 4.

In the housing 2, the cover 2b illustrated above covers the base unit 2c at the vehicle entry point side (that is, the vehicle entry point side that is the entry point of the vehicle 200 entering along the first direction L) of the vehicle charging device 1. As illustrated in FIG. 14, the housing 2 is provided with a pair of side covers 2e that are spaced apart from each other in the second direction W and fixed to the base unit 2c at the vehicle entry point side. The cover 2b is disposed to be sandwiched between the pair of side covers 2e.

In the vehicle charging device 1, the second sliding body 3B is disposed in the space surrounded by the base unit 2c, the cover 2b, and the pair of side covers 2e. The second sliding body 3B slides in the first direction L between a housing position where the second sliding body 3B is housed between the pair of side covers 2e, and a pulled-out position where the second sliding body 3B is pulled out from between the pair of side covers 2e. The cover 2b covers the second sliding body 3B and the base unit 2c together at the housing position. The exemplified second sliding body 3B at the vehicle entry point side is disposed at the housing position in the space surrounded by the base unit 2c, the cover 2b, and the pair of side covers 2e, and this vehicle entry point side is pulled out from the housing position to the pulled-out position. The exemplified cover 2b then covers the second sliding body 3B in the vehicle entry point side at the housing position. In addition, the pair of side covers 2e covers the second sliding body 3B in the vehicle entry point side at the housing position, with the second sliding body 3B at the vehicle entry point side sandwiched.

As illustrated in FIG. 14, the second sliding body 3B has a front end cover 3b on the front end portion of the vehicle entry point side. The front end cover 3b includes a cover main body 3b₁ that covers the front end portion of the second sliding body 3B at the vehicle entry point side, and a pair of protruding portions 3b₂ each of which protrudes from each end of the cover main body 3b₁ in the second direction W toward the second direction W and covers each end portion 2e₁ of the pair of side covers 2e in the vehicle entry point side at the housing position from the outside.

The cover main body 3b₁ covers the front end portion of the second sliding body 3B in the vehicle entry point side at the housing position from the first direction L and the third direction Z. The protruding portions 3b₂ cover the end portions 2e₁ of the side covers 2e at the housing position from the first direction L and above and allow the end portions 2e₁ of the side covers 2e to receive the external load applied to the cover main body 3b₁ at the housing position. For example, in the vehicle charging device 1, when the vehicle 200 enters from the vehicle entry point side while moving forward or backward, a wheel Ty may be brought into contact with the front end cover 3b from the vehicle entry point side because of misalignment of the vehicle 200, and the wheel Ty may then climb on the top of the cover 2b. Therefore, in the vehicle charging device 1, it is necessary not only to reduce the space for the routing structure as illustrated above, but also to improve durability by employing a load-bearing function to resist the external load from the wheel Ty due to contacting with or climbing of the wheel Ty. In the vehicle charging device 1, in a case where the wheel Ty is brought into contact with the front end cover 3b (for example, cover main body 3b₁) in the housing position, the external load from the wheel is transmitted from the pair of protruding portions 3b₂ to the end portions 2e₁ of the pair of side covers 2e. In the vehicle charging device 1, the pair of side covers 2e are fixed to the base unit 2c, so that the external load from the wheel can be received by the end portions 2e₁ of the pair of side covers 2e. Therefore, the durability of the vehicle charging device 1 can be improved.

Here, in the vehicle charging device 1, since the above-described load-bearing structure (hereinafter, referred to as a “first load-bearing structure”) 300 is provided between the base unit 2c and the cover 2b, the two load-bearing structures (second load-bearing structure) 400 formed with the protruding portions 3b₂ of the front end cover 3b, the end portions 2e₁ of the side covers 2e, and the base unit 2c ensures the load-bearing function when the wheel Ty is brought into contact with the front end cover 3b in the housing position, and the first load-bearing structure 300 ensures the load-bearing function when the wheel Ty climbs over the front end cover 3b and rides over the cover 2b.

The contents disclosed in the above embodiment may be combined and implemented as appropriate.

The vehicle charging device according to the present embodiment has the routing structure including the curved portion that is curved in a U-shape and following the movement of the sliding body while changing the position of the curved portion. Thus, the vehicle charging device according to the present invention has the effect of reducing the space for the routing structure.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle charging device comprising:
a base unit that is fixed to a floor unit;
a sliding body on which a connector is disposed, the connector being configured to fit with an inlet disposed in a vehicle, and the sliding body being slidably supported by the base unit; and
a routing structure that is routed between the base unit and the sliding body, has a curved portion curved in a U-shape, and is configured to follow a movement of the sliding body while changing a position of the curved portion.

2. The vehicle charging device according to claim 1, wherein
the routing structure includes a first exterior member, a first electric wire inserted into the first exterior member, a second exterior member, and a second electric wire inserted into the second exterior member,
an outer diameter of the second electric wire is smaller than an outer diameter of the first electric wire, and
the second exterior member is disposed alongside the first exterior member such that the second exterior member is positioned radially inward relative to the first exterior member at the curved portion.

3. The vehicle charging device according to claim 2, wherein
a cross-sectional shape of the second exterior member is rectangular with a width along an axial direction of the curved portion being wider than a width in a radial direction.

4. The vehicle charging device according to claim 3, wherein
a cross-sectional shape of the first exterior member is rectangular with a width along the axial direction of the curved portion being wider than a width in the radial direction, and
a flattening of the second exterior member is greater than a flattening of the first exterior member.

5. The vehicle charging device according to claim 1, further comprising:
a cover that covers the base unit; and
a load-bearing structure that is disposed between the base unit and the cover, wherein
the sliding body includes a first sliding body and a second sliding body,
the first sliding body is supported by the base unit and configured to slide in a second direction with respect to the base unit,
the second sliding body is supported by the first sliding body and configured to slides in a first direction with respect to the first sliding body, and
the load-bearing structure includes a prop disposed between the cover and the first sliding body, a prop disposed between the cover and the second sliding body, a buffer member interposed between the first sliding body and the base unit, and a buffer member interposed between the second sliding body and the first sliding body.

6. The vehicle charging device according to claim 1, further comprising:
a cover that covers the base unit at a vehicle entry point side as an entry point of a vehicle entering along a first direction; and
a pair of side covers that are fixed to the base unit and spaced apart from each other in a second direction at the vehicle entry point side, wherein
the sliding body includes a first sliding body that is supported by the base unit and configured to slide in the second direction with respect to the base unit, and a second sliding body that is supported by the first sliding body and configured to slide between a housing position where the second sliding body is housed between the pair of side covers, and a pulled-out position where the second sliding body is pulled out from between the pair of side covers, in the first direction with respect to the first sliding body,
the cover covers the second sliding body and the base unit together at the housing position,
the second sliding body includes a front end cover provided with a cover main body that covers a front end portion of the second sliding body at the vehicle entry point side, and a pair of protruding portions each of which protrudes from each end of the cover main body in the second direction toward the second direction and covers each end portion of the pair of side covers in the vehicle entry point side at the housing position from an outside, and
the protruding portions allow the end portions of the side covers to receive an external load applied to the cover main body at the housing position.
